(19) United States
(12) Patent Application Publication
(10) Pub. No.: US 2008/0098902 A1
(43) Pub. Date: May 1, 2008

(54) Multi-functional outdoor cooker using multiple fuels and transportable via receiver hitch of vehicle or trailer

(76) Inventors: Patrick Mansfield, Locust Grove, AR (US); Richard Andro Matthews, Drasco, AR (US)

Correspondence Address: Richard Matthews, 155 Timber Ridge Road, Drasco, AR, 72530, US

(21) Appl. No.: 11/586,904

(22) Filed: Oct. 26, 2006

(51) Int. Cl. A47J 37/07; A47J 37/04; A47J 37/12; A47J 37/06

(52) U.S. Cl. 99/339; 99/340; 99/341

(57) ABSTRACT

A portable grill and cooker which can be transported on a vehicle's trailer hitch, on a separate trailer, or used as a free-standing stationary grill. This grill can also be used to bake, griddle fry, deep fry, boil, steam, smoke, and barbeque different foods. The grill can utilize propane, wood, or charcoal to provide a heat source for cooking. It includes a storage compartment as well as wheels/casters on adjustable-height legs to permit relocation easily, and a trailer hitch adapter which permits easy hookup and raising without the user having to physically lift the grill by hand.

### REFERENCES USED

U.S. Patent Documents

| | | |
|---|---|---|
| 3605718 | September 1971 | Winters |
| 4347830 | September 1982 | Runyan |
| 4518189 | May 1985 | Belt |
| 4,757,756 | July 1988 | Van Marr |
| 5263467 | November 1993 | Jones |
| 5310147 | May 1994 | Billman |
| 5411011 | May 1995 | Teta |
| 5626126 | May 1997 | McNulty |
| 5,640,949 | June 1997 | Smith |
| 6263867 | July 2001 | Skelton |
| 6,354,286 | March 2002 | Davis |
| 6,588,418 | July 2003 | Loving |
| 6708604 | May 2003 | Deichler, Jr.; Richard A. |
| 6,701,913 | March 2004 | LeDuc, et al |
| 6,725,855 | April 2004 | Brennan |

Current US Class
99,419
D07,332
99,422
99,467
280,186
99,403
99,324

### BACKGROUND OF THE INVENTION

This invention was originally described by provisional patent application No. 60/731906 filed by the same inventors, and has been described on their website “grillbq.com” during the provisional patent coverage.

We have invented an outdoor cooker which is both versatile and transportable on a vehicle's trailer hitch or via trailer. We desired to design a multifunctional barbeque which could also bake, griddle fry, deep fry, and smoke foods, as well as being better made and more transportable than prior art devices. Our observations of the prior art led us to conclude that the only grills available that were transportable were only capable of charcoal grilling and/or gas grilling, and additionally these grills were not constructed in a durable manner or large enough to cook for more than a small family. On the other extreme were smokers which were typically large heavy trailers, which could not be used for other than smoking meats or barbeque.

The problem with the prior art of hitch transportable grilling technology is that the grills must be light enough to be lifted and attached to the trailer hitch. In addition, once they are attached, most cannot be removed and used to cook elsewhere. We designed, as part of our invention, a hitch carrier mount which uses a hydraulic jack to lift the grill, enabling a person of average strength to load and lift the 500 lb grill. In addition, we designed the grill so that it has wheels of its own, which can be used to move it to the cooking location once it is unloaded. The reasoning behind this functionality is that there are occasions when it is not possible to park close to where one would like to cook. In addition, we wanted the design to permit one person to load or unload the grill without having to lift it.

The durability/materials issue was therefore resolved by being able to construct the cooking device with materials more suited to the cooking need, without quite so much consideration for weight.

We observed that the prior art grills were typically either gas grills, charcoal grills, or smokers, but not combinations of those. Having the functionality to use all three modes, with at least two simultaneously, was a design objective. We accomplished that, being able to use gas to grill, gas to deep fry or boil, wood to smoke or grill or griddle fry, and charcoal to grill or griddle fry (or smoke lightly, with the use of presoaked wood chips on hot charcoal). In addition, we added the functionality of having a foldable oven component which is used over the wood/charcoal firebox, and can be used for baking or as a warmer for food which is already cooked.

### DETAILED DESCRIPTION OF THE INVENTION

The preferred embodiment of the cooker is comprised of a plurality of steel plates welded together to create three major compartments and two smaller ones.

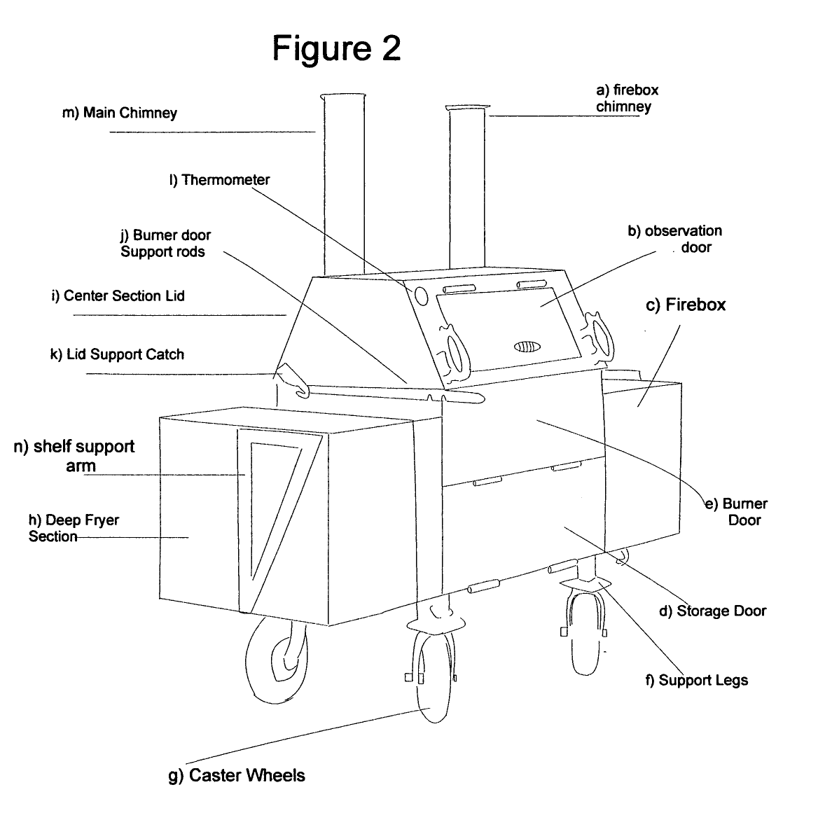

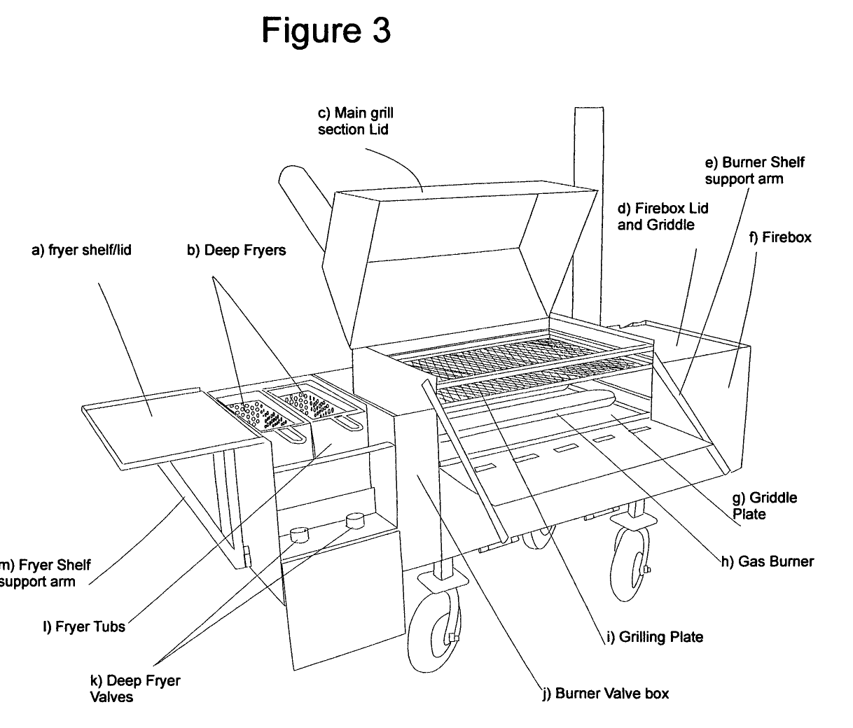

One major compartment at the left end comprises the deep fryer/boiler section (FIG. 2h), which contains two removable containers made of stainless steel with drains installed (FIGS. 3b,l,k). Said containers each hold a stainless steel basket with handle to be used for deep frying or boiling, so as to be able to pull the food out of the oil or water easily. Said stainless steel containers are positioned over a gas burner located in the lower portion of the said left compartment, with said gas burners including individual controls (FIG. 3k) to permit control over the temperature of fluids in said fryer containers. Said fryer section has a lid (FIG. 3a), which is hinged at the horizontal edge at the upper left side of said fryer section. Said fryer section lid can be pivoted around said hinge and oriented to the left of said fryer section, horizontally and parallel with top edge of said fryer section, thereby comprising a shelf which can be used as a surface to place food or cooking tools upon during the frying/boiling cooking process.

Said lid/shelf component is supported in its open/shelf configuration via a swing-away support (FIGS. 2n, 3m), which is hinged vertically along the center of the outside left side of said fryer section such that said support can be folded flat against said fryer section and pinned securely in said configuration for travel purposes.

The second, center compartment created by said plurality of welded steel plates is used as the main cooking section. Said main section has a hinged lid (FIGS. 2i, 3c), permitting full access to the grill surfaces contained therein. Said lid optionally includes a rotisserie composed of horizontally oriented steel or stainless steel rod, with its ends captured in “u” shaped brackets on the inner surface of the vertical ends of said lid. One end of said lid includes indexing holes or grooves which correspond to protrusions on said horizontal rod. Said rod includes smaller parallel rods at one end, oriented to be spaced from said center rod and with sharpened points oriented toward the mid-point of said rod. Said rotisserie apparatus can be used by removing said rod from said lid, and impaling the food to be cooked, a chicken for example, upon said rod. Said smaller rod sections serve to secure said food item such that said rod cannot rotate without the food rotating with it. In addition said lid has a hatch opening on its frontal surface (FIG. 2b), hinged at its horizontal surface, which permits visual inspection of food without losing all accumulated heat. Said main cooking section has slots located horizontally along it right, left, and back vertical surfaces, for the positioning of solid or expanded metal grill tray surfaces (FIGS. 3i,g) which can be used for smoking, grilling, barbeque, or griddle frying cooking operations. Said solid metal grill surface can alternately be positioned above the gas burners (FIG. 3h) located in the bottom of main compartment, serving as drip trays during smoking operations using wood heat.

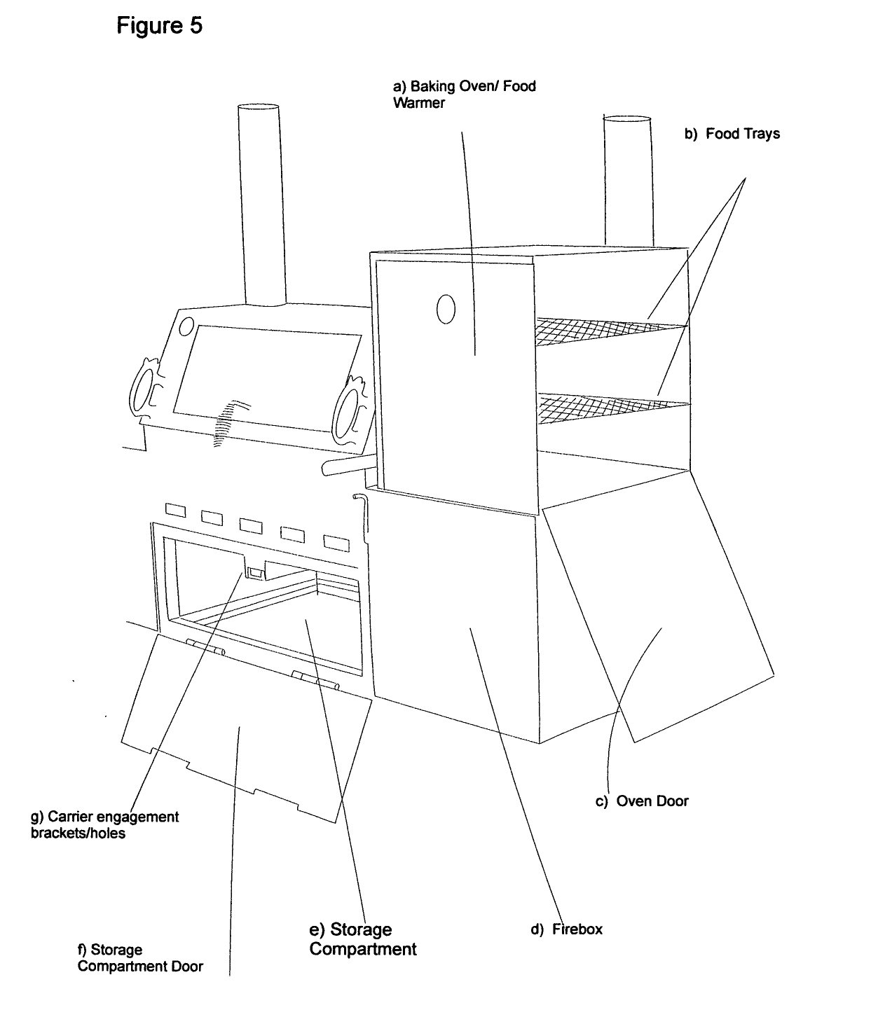

Said solid metal grill surface can also alternately be positioned below said gas burners, serving as a drip tray during gas grilling and thereby facilitating cleanup after the cooking is over. Said center grill section has a front panel (FIG. 2e, FIG. 3) hinged at its lower horizontal surface permitting full access to gas burners and lower slots for said grilling surface. Lower section of said center section forms, via a plurality of perimeter steel plating including the bottom of said center cooking compartment a separate storage/warming compartment. Said storage compartment has a front panel (FIGS. 2d, 5f,e) hinged at its lower horizontal surface so as to permit access to storage contents as well as access to hitch mount hardware contained in storage compartment's upper surface. Upper surface of said storage compartment includes welded steel plate (FIG. 5g) with perforated holes which serve to capture the square steel shaft of the carrier, when said carrier is inserted into vehicle's trailer hitch. Said perforated holes serve to provide a method of pinning the carrier shaft onto the cooker grill to permit lifting and transporting. Said storage compartment has a steel divider plate which is hinged along Said center section of cooker grill and its lower storage/warmer compartment are situated above and around, respectively, the support frame and legs (FIG. 2f) of the cooker grill. Said storage compartment contains/captures said support frame, which is made of fully welded square tube steel. Said support frame has four vertical square tubes at its corners, which serve to capture vertically oriented square tube steel legs. Said legs are proportioned so as to slide telescopically into said support frame vertical corner tubes. Said leg tubes and support tubes have horizontally oriented holes drilled through, with said leg tubes having several such holes at regular intervals. Said holes are for the purpose of capturing horizontally inserted pins, so as to permit adjustability of said legs either for travel purposes or for height adjustability to accommodate different heights of users/cooks. Said horizontally inserted pins have holes perpendicular to their length to permit insertion of cotter pins or similar devices to prevent accidental removal of a pin. Said legs terminate at the lower end with a rotating caster wheel (FIG. 2g) thereby permitting easy rolling of the grill. Said lid of said center grill section includes horizontal pivot pins about its far side, to permit hinging about a horizontal axis while opening said lid. Said lid also has two hooks (FIG. 2k) adjacent to said lid pivot, which serve to engage a second set of fixed pins which hold said lid in the open position without the user having to support said lid. Said hooks are shaped so that when the user pulls downward on said lid, said hooks will disengage automatically and permit lid lowering.

Hinged front panel of said center section has two horizontally oriented steel plates, (FIGS. 2j,3e) which engage in fixed pins located along the lateral vertical surfaces of said center cooker section. Said steel plates serve to hold said hinged front panel in either a closed, vertical position, or in an open horizontal position depending on which set of said fixed pins said plates are hooked onto.

Said center cooker grill lid also includes a smokestack/chimney, (FIG. 2m) oriented in a vertical axis and positioned about said lid's left horizontal upper surface. Said chimney includes a flap above its uppermost surface and oriented horizontally such that said flap can serve to occlude opening of said chimney pipe. Said flap has a vertically oriented pivot point attached to said pipe, permitting it to be adjusted to an open, closed, or partly open position in order to regulate the flow of heat and smoke.

The right end of said cooker is comprised of the firebox (FIGS. 2c, 3f, 4). Said firebox consists of a welded steel plate container which serves to contain wood or charcoal fires for the purpose of generating heat and smoke to be used for indirect cooking of food in said center cooker section using heat and smoke. Said firebox includes an opening in its bottom surface with a sliding steel plate cover which serves to allow the removal of ashes from the firebox after the wood and charcoal has been burned. The metal plate which forms the common surface between said center cooker section and said firebox includes an opening across its upper edge, which serves to permit the passage of heat and smoke from said firebox into said center section. Said vent opening has a steel flap flue arranged around a horizontal hinge which serves to permit the adjusting of the amount of heat and smoke which passes into said center cooker section. Said firebox also includes a chimney (FIG. 2a) which permits the heat to exit the firebox. Said chimney pipe includes a cover over its uppermost end, hinged at the edge of the chimney about a vertical axis, such that said cover can variably occlude the chimney pipe. This permits the regulation of heat/smoke flow from the firebox to the center cooker section by adjusting said chimney covers on both the firebox and the center grill section, as well as the variably flue over the opening which connects said firebox and center section.

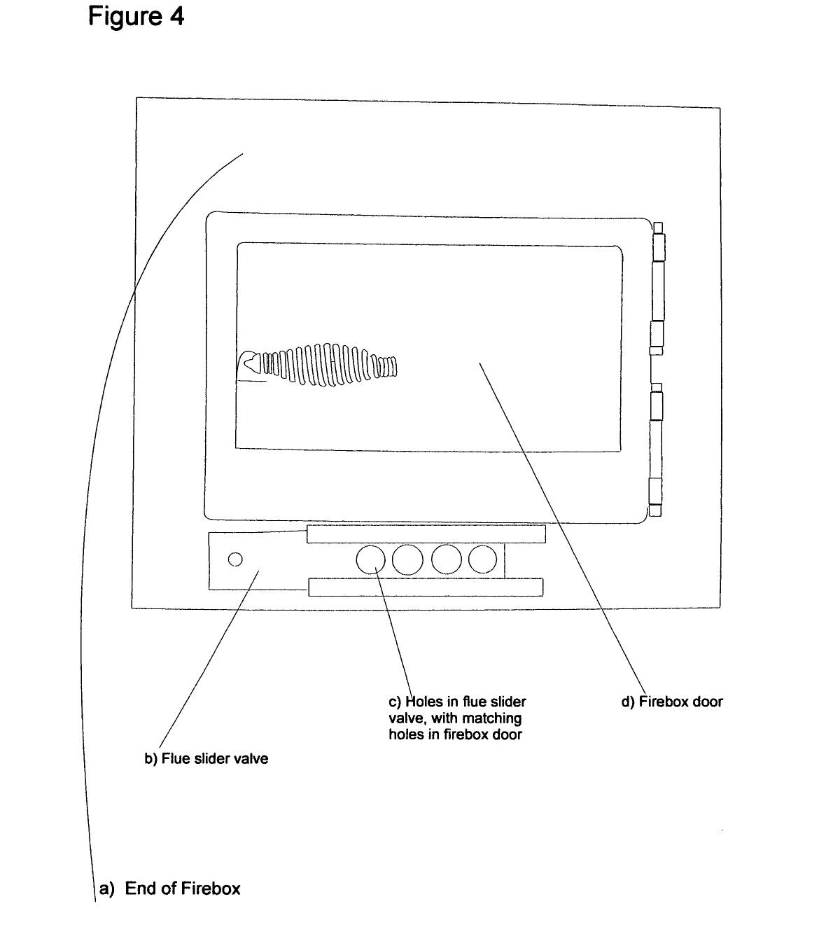

Said firebox has a horizontal upper surface/lid (FIG. 3d) which consists of a steel plate with a continuous flange welded about its edge at a perpendicular upward angle forming a raised edge around its perimeter. Said removable lid/flange serves to form a griddle cooking surface which can be used either to cook directly upon, to cook bacon for example, or as a hot plate for a skillet or pot. The four vertical plate sides of said firebox have welded flanges on each side in a horizontal orientation at identical heights. Said flanges form a shelf, which serves to hold a grilling surface made of expanded steel with a reinforcing edge welded on. Said grilling surface can be used to grill or barbeque directly over the wood or charcoal fire lit in said firebox, with or without said griddle/lid in place over said firebox. Said firebox has a steel plate door (FIG. 4d) in the side farthest from said center grill section, with a hinge arranged along a vertical axis on its right side, and a handle/latch to secure said door in a closed orientation. Below said door on said firebox vertical surface there are four round holes, with a sliding plate (FIG. 4c) also perforated with four holes oriented so that said plate can be moved laterally to allow the uncovering of some or all of said holes in firebox wall. Said orientation of holes and sliding plate allows the regulation of airflow to wood or charcoal fire in said firebox, so as to be able to regulate the generation of heat and/or smoke to cook with.

The grill includes an oven component (FIG. 5a) which is composed of five plates of steel which fit together with the top of the firebox (FIG. 5d). FIG. 5 shows the orientation of said oven upon said firebox. Said oven plates are designed in such a manner that they interlock and permit easy assembly/disassembly, and fit in the storage compartment (FIG. 5e) when not in use. Said oven can be used for baking or warming food when there is a fire in said firebox to provide the required heat for either procedure. Said firebox includes raised ridges along the inner surface of opposing vertical sides to permit the support of two or more food trays (FIG. 5b) which serve to provide support for food placed inside said oven. Additionally said oven includes a perforated steel plate below said trays, which serves as a heat diffuser plate thus preventing the possibility of hotspots and burned food.

### BRIEF SUMMARY OF THE INVENTION

This invention is a transportable multi-functional outdoor cooker. It is an improvement on prior art outdoor cookers for several reasons:
a. Transportable on trailer hitch, trailer, or free-standing. Prior art grills are usually stationary; other hitch portable grills are not as versatile, large, or durable.
b. Can be rolled to cooking location once unloaded from hitch
c. Burns wood, charcoal, or gas. Prior art grills use only one of these.
d. Multiple cooking capability, not just grilling:
   Barbeque
   Smoker
   Grill
   Rotisserie
   Griddle
   Deep Fryer
   Boiler/Steamer
   Baking Oven
e. Strength/Quality/Durability-made from CNC cut heavy-gauge steel, where the rest of the transportable grills are made of light gauge stamped metal.
f. Versatility of the components: for example, the grill has a solid tray that may be inserted in one of the top three slots in the main cooker section and used as a griddle for cooking pancakes, bacon, homefries, eggs, etc. This same solid tray may be inserted in the slots over the gas burners, in which case it serves as a drip tray while meat is being smoked. In this position, it can also be used to hold charcoal or wood, to use the main grill section as a charcoal grill or as a wood-fired grill. Or, this tray may be inserted below the gas burners, in which case it serves as a drip tray during gas grilling, facilitating the clean-up process after the user is finished cooking.

### DESCRIPTION OF ILLUSTRATIONS

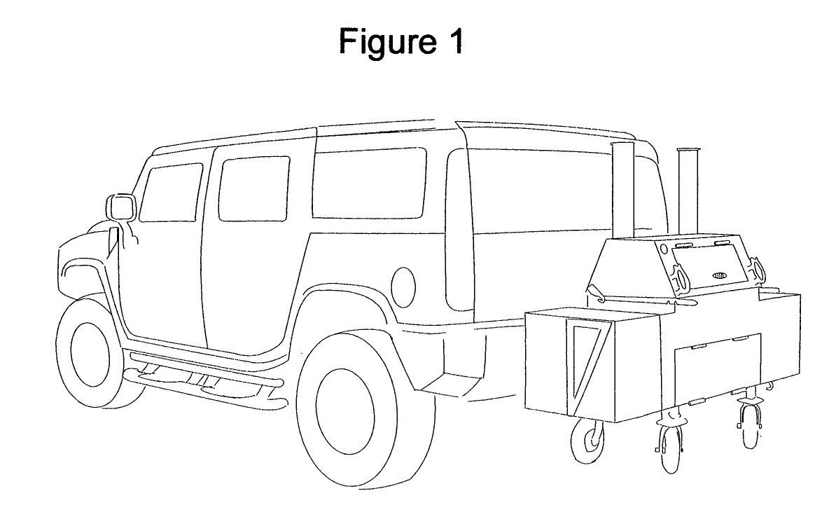

### FIG. 1:

FIG. 1 shows the grill in its transportation mode, connected to the trailer hitch of an SUV In this configuration the support legs are elevated so that the caster wheels do not contact the roadway. The carrier mechanism is pinned such that the jack does not support the weight of the grill. This configuration permits mobility, as well as access to some areas where barbeque grill trailers may not be permitted.

### FIG. 2:

This illustration shows the grill unloaded from the carrier and vehicle. This configuration is closed and illustrates how the grill would be rolled to its cooking destination. This illustration is useful for showing the different components and sections of the grill.

a) This is the firebox chimney. It has an adjustable flue at the top, which is used to regulate the passage of smoke/heat out of the firebox. When smoking in the center compartment, this chimney is closed off so that the smoke will go through into the center compartment.

b) This is the observation door, which is used to be able to view the food that is grilling or smoking in the center section. Using this door instead of opening the whole lid prevents the escape of heat and makes cooking more efficient. This door is also much lighter than the main lid, so it is also easier to use to check on the food.

c) This is the firebox. The firebox is where wood fires or charcoal fires are burned to provide heat and smoke during the smoking process. It is also possible to light a wood or charcoal fire in the firebox and use its heat to cook in the main grill section, without smoking the food. This is done by regulating the chimney flues and the firebox door flue so that the fire within is hot enough to not be smokey. The firebox is also what generates the heat that is used during the baking process, when the accessory baking oven is placed upon the firebox. This firebox has additional functionality in that the lid of the firebox is removable, revealing a grilling surface underneath. This permits the user to use only the firebox if only a small quantity of food is to be grilled. Alternately, this surface can be used in addition to the main center grill, for cooking larger quantities of food. The lid of the firebox is configured in such a way that it can be used as a griddle, so that the user can cook a number of items directly upon the lid surface. It can also serve as a hot plate, to place a skillet or pot upon to keep items warm or cook with.

d. This is the storage compartment door. The storage compartment allows the storage and transportation of several items, including the folded baking oven and some cooking utensils. It is also the access point which is used to bolt the carrier assembly onto the grill when preparing to travel.

e. Burner Door. This is the door that is used to access the front of the gas burners. When cooking, this door can be left open 90 degrees, so that it forms a shelf in front of the cooking space to place items on while cooking.

f. Support Legs. These hold up the grill when situated on the ground, and are telescopic so that the wheels can be elevated out of the way when transporting. These also permit height adjustment to accommodate users that are taller or shorter in stature.

g. Caster Wheels. These are the swiveling, pneumatic tires that support the grill when it is on the ground and not up on a trailer hitch. All four wheels have swivels, permitting great mobility for the user when rolling the grill to a cooking location, as well as when rolling the grill up to the back of the carrier vehicle to prepare for travel. These casters bolt onto the flat plate at the bottom of each support leg. When the grill is configured for trailer use, these casters are unbolted, and the flat plates are bolted to the floor of the utility trailer.

h. Deep Fryer Section. This portion of the grill incorporates two separate deep fryer tubs and baskets, with individual burners and controls. Two separate fryers permit the user to fry foods that taste very differently, such as fish and french fries or funnel cake, and not have one smell or taste like the other. In addition, one can be used for boiling or steaming, or cooking other foods like baked beans or stew or soup.

i. Center Section Lid. This is the main lid for the center portion of the grill. This lid incorporates the observation door described above, as well as having its own chimney (see below). The center section lid serves to hold in the heat from the gas burners as well as the smoke from the firebox, and allows more rapid cooking as well as better control of the cooking process.

j. Burner Door Support Rods. These pieces are what supports the burner door when it is in the open position, as well as being the latch mechanism that holds the burner door closed when it is not in use.

k. Lid support catch: This is the catch which holds the center section lid in an open position when the user is accessing the grilling surfaces of the main section.

l. Thermometer: This is so that the user can monitor the cooking compartment temperature when cooking food in the main center section of the grill. It is particularly useful when the user is smoking meat using a wood fire in the firebox, as this process requires a carefully controlled temperature.

m. Main Chimney: This is the chimney that vents the main center section of the grill. This chimney has a flue at the top, which is used to regulate the airflow through the main center grill section.

n. Shelf Support Arm: This piece is hinged on the side of the deep fryer section, and swings out perpendicular to the left edge of the fryer section to provide support for the shelf. The shelf is also the lid to the fryer section, and is hinged at the left end of the fryer so that it can swing over and become a shelf.

### FIG. 3:

a: This is the deep fryer shelf, in its extended position. This shelf is useful for placing food items that either are about to be fried or have just come out of the fryer.

b: These are the deep fryer baskets. These baskets hold the food that is being fried and strain off the oil when they are lifted out of the hot oil. The baskets include clips so that they can be held easily at the correct level to be out of the oil so that the excess oil will drain off.

c: Main cooking section lid: this is the lid that keeps all the smoke and/or heat on the food which is being prepared in the center section of the lid. It includes its own chimney for heat/smoke regulation, and also includes the thermostat as well as an observation door.

d: Firebox lid and griddle: this allows frying of food items such as bacon or sausage or pancakes using the wood fire in the firebox as a heat source. The firebox lid is removable for easy cleaning.

e. Burner shelf support arm: this permits latching of the burner shelf in an open position, as shown in FIG. 3. This shelf is useful to place cooking utensils or food items on. The support arms also latch the shelf in a closed position when not in use.

f. This is the firebox, which is where the wood fire is built to provide heat and smoke for cooking, particularly when smoking meats. There is an adjustable flue, not shown in the illustration, which allows the regulation of smoke flow into the main center section of the grill.

g. This is the griddle plate. This piece has different uses depending on where it is installed. As shown in FIG. 3, it is serving as a drip tray below the gas burners. When using the gas burners for gas grilling, this orientation facilitates cleanup. The griddle plate can be placed over the gas burners, and be used as a griddle to fry food on. In addition, when smoking meats using the perforated trays, the solid tray can be placed below the perforated trays so as to serve as both a drip tray and a water reservoir to keep the meats moist.

h. Gas burners, which provide the heat for gas grilling or griddle frying.

i. Grilling plate, which is used for either smoking meats or for gas grilling. Made from expanded metal, the perforations allow the heat and airflow needed to thoroughly cook the food.

j. The burner valve box, which holds the hosing and valve hardware. The valves for the center section gas burners are on the top surface of this box.

k. Deep fryer valves, to regulate the heat from the two deep fryer burners.

l. Fryer tubs, which are stainless steel and removable. These hold the hot oil for frying, or the water for boiling or steaming operations, or soup, chili etc. The tubs have a drain at the bottom which exits the rear of the grill, so that they may be emptied while hot to prepare for travel.

m. Fryer shelf support arm, shown in extended position as it holds up the fryer shelf.

### FIG. 4

a. End of firebox, which is on the right of the grill.

b. Flue slider/valve, which is used to regulate the airflow into the firebox and therefore to regulate the heat of the fire therein. This is what permits the user to restrict the airflow enough to generate the quantity of woodsmoke needed to properly smoke meats.

c. Holes in flue slider, which align with corresponding holes in the firebox door. Moving the slider right or left changes the alignment of the two sets of holes, thereby providing more or less opening for the passage of air to the fire in the firebox.

d. Firebox door, which allows the user access to the firebox to build and tend the fire within.

### FIG. 5

a. Baking oven and food warmer. This component folds flat and stores in the storage compartment when not in use. The oven/warmer gets its heat from the fire in the firebox, and heat is regulated via a flue on the top surface of the firebox. The oven may be used to bake food, such as bread, or it may be used to keep food warm when it has already been cooked but not served yet.

b. Removable Food trays inside the oven to place food upon for baking or warming.

c. Oven door which opens to access the Food Trays inside, and keeps the heat in while baking or warming food.

d. Firebox: for wood or charcoal fires, as discussed above.

e. Storage compartment: used for storing the folded Baking Oven, as well as cooking utensils or other items. Right third of storage compartment can also be used as a warming oven when Firebox has a fire, due to its proximity to the Firebox.

f. Storage compartment door, to provide a way to keep things from falling out!

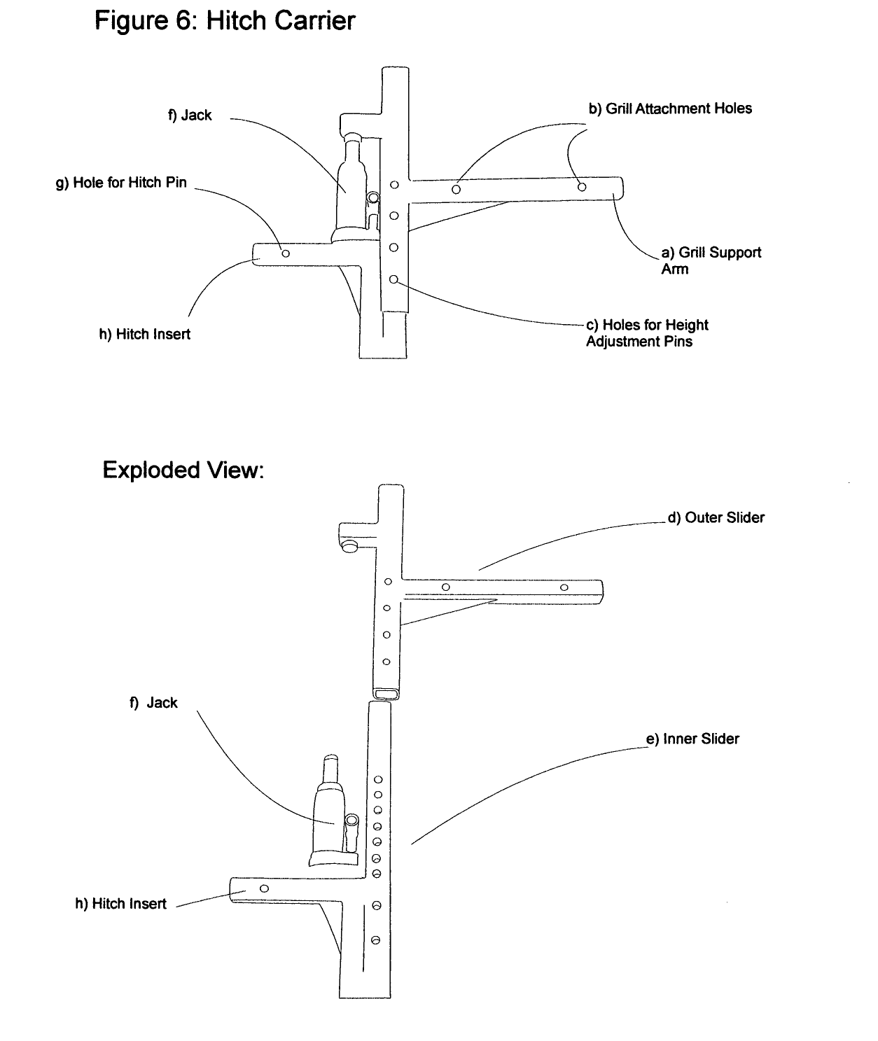

### FIG. 6: Hitch Carrier

a: Grill Support Arm: This is the part that slides into the back of the Grillbq and supports the grill during transport.

b: Grill Attachment Holes: where bolts pass through, to attach the grill to the Support Arm. Using bolts instead of pins reduces the sway of the grill while driving.

c: Holes for HeightAdjustment Pins: these holes pass through both the inner and outer sliders. When the grill is at the desired height for transport, pins are inserted in these holes. The jack is then lowered slightly, allowing the pins to carry the weight of the grill instead of the jack.

d. Outer Slider: this piece slide over the inner slider, permitting a telescoping height adjustment during transport. The Outer Slider is the part that attaches to the Grill.

e. Inner Slider: This piece slides into the outer slider, permitting telescoping height adjustment. The inner slider is the part that attaches the vehicle's trailer hitch receiver.

f. Jack: this jack is what is used to raise or lower the grill during loading or unloading from the Hitch Carrier. It may be a hydraulic bottle jack as shown, a scissors jack, or an electric jack.

g. Hitch Pin Hole: this is where a pin is inserted through the Hitch Insert and the vehicle's receiver hitch.

h. Hitch Insert: this is the part which inserts into the vehicle's receiver hitch, where it is pinned.

We claim:

1. A new method of affixing a portable grill to a trailer hitch using a hitch carrier such that said grill can be easily and safely lifted into place by a user of moderate physical strength.
a) Said hitch carrier is composed of two tubular telescoping sections with both said sections having a horizontally oriented square steel tube affixed at 180 degrees of opposition in the horizontal plane.
b) Said hitch carrier further includes attachments for a mechanical, hydraulic, scissors, electric or other jack which is used to provide the lifting force to lift said grill to transport height with a minimum of effort.
c) Said hitch carrier has holes drilled in its horizontally oriented tubular sections such as to permit one tube to be inserted and pinned to a vehicle's trailer hitch receiver and the opposing tube to be inserted and bolted into the base/supporting structure of the gril, supporting said grill during the lifting and transport phases of use.
d) Said grill includes in its support structure four tubular telescoping legs with rotating caster wheels such that said legs can be pinned via pins inserted in corresponding horizontally oriented holes through outer tube of said legs, permitting rapid height adjustment such as to provide adequate ground clearance when transporting on said vehicle's trailer hitch, and such that the caster wheels at the bottom of said legs permit the user to roll the grill into the desired cooking location.

2. We claim a new combination of cooking components that have not been used together in prior art grills, with said combination permitting a plurality of cooking functions including grilling, barbeque, rotisserie, deep frying, boiling, steaming, baking, griddle frying, and offset smoking as well as simultaneously using several different said cooking functions.
a) Said grill includes one or more stainless steel containers over a variable heat source, including optional strainer baskets, providing functionality for either deep frying in hot oil, boiling in water, steaming with small quantities of water, or the making of soups, stews, beans and similar dishes requiring a heated cooking receptacle.
b) Said grill includes a cooking portion comprised of gas-fired burners in the bottom, with several slots above said burners for the indexing and placement of two types of different trays with one being a solid tray and the other being made of perforated or expanded metal, such that the perforated/expanded trays can be used for smoking, gas grilling, or cooking over charcoal, and said solid trays can be used as drip trays under the perforated ones, drip tray under the gas burners, or charcoal supporting surface over the gas burners, or additionally as a griddle cooking surface over said gas burners or charcoal.
c) Said grill includes an offset firebox with adjustable airflow, said firebox being used for either charcoal or wood fires and to generate smoke, which is conveyed to the adjacent grill segment which has trays with food on them such that said food is either cooked by the heat, seasoned by the wood smoke, or both.
d) Said grill includes an adjustable flue and opening between said firebox and said grill portion, with said flue being used to regulate the quantity of the smoke/heat passing to the adjacent compartment as to permit the precise regulation of heat and smoke to optimize the flavor of the food being cooked.
e) Said grill includes a chimney or chimneys each with adjustable flue which serve to provide a method of regulation of airflow through said grill so that the user may regulate the airflow and heat that is applied to the food therein, permitting accurate regulation of the speed of the cooking process as well as the smoke flavor.
f) Said grill includes a hinged lid over the center section with gas burners, with said lid being hinged to the grill section via horizontally oriented hinges along corresponding edges of both lid and grill, with said lid including a horizontally oriented stainless steel rod with multiple position rotary indexing, said rod being designed to function as a rotisserie permitting three or more positions of rotation to permit the even cooking of meat placed upon said rotisserie rod and therefore over the heat source.

3. Said grill is further capable of utilizing wood, charcoal, or propane for a source of cooking heat so that the user has the option of using the fuel of choice.
a) Said grill includes a firebox section to provide heat and smoke for offset smoking, baking, griddle frying with the adjustable chimney flue and adjustable air intake vent allowing for fine-tuning of the fire regardless of type of fuel.
b) User may cook food in the center section of the grill using heat generated by the gas burners in said section, and then start a small charcoal or wood chip fire in the firebox to provide smoke for seasoning purposes only, with said smoke passing through the adjustable flue between these two respective portions of said grill.
c) User may cook in center grill section using heat from the gas burners in said section, using a solid tray underneath said burners to serve as a drip tray, or user may place said drip tray in uppermost slot of said grill section over said gas burners, using said solid tray as a griddle to fry on, or user may place said solid drip tray just above said gas burners to use as a drip tray while smoking meat in said center grill section, or user may use said drip tray as a charcoal receptacle to allow the use of charcoal for a heat source in said center grill section.
